(19) United States
(12) Patent Application Publication
(10) Pub. No.: US 2004/0024960 A1
(43) Pub. Date: Feb. 5, 2004

(54) CAM diamond cascade architecture

(76) Inventors: Lawrence King, Carp (CA); Robert McKenzie, Ottawa (CA); Alan Roth, Austin, TX (US); Sean Lord, Stittsville (CA); Dieter Haerle, Kanata (CA)

Correspondence Address: Robert D. Kucler, Esq., Reed Smith LLP, P.O. Box 488, Pittsburgh, PA, 15230-0488, US

(21) Appl. No.: 10/306,720

(22) Filed: Nov. 27, 2002

(30) Foreign Application Priority Data
Jul. 31, 2002 (CA) 2396632

(51) Int. Cl. G06F 12/00

(52) U.S. Cl. 711/108; 711/167

(57) ABSTRACT

A multiple CAM chip architecture for a CAM memory system is disclosed. The CAM chips are arranged in a diamond cascade configuration such that the base unit includes an input CAM chip, two parallel CAM chip networks, and an output CAM chip. The input CAM chip receives a CAM search instruction and provides the search instruction and any match address simultaneously to both CAM chip networks for parallel processing of the search instruction. Each CAM chip network provides the highest priority match address between the match address of the input CAM chip and its own match address. The output CAM chip then determines and provides the highest priority match address between the match addresses of both CAM chip networks and its own match address. Each CAM chip network can include one CAM chip, or a plurality of CAM chips arranged in the base unit diamond cascade configuration. Because the clock cycle latency of the diamond cascade configured CAM memory system is determined by sum of the inherent CAM chip search latency and the number of parallel levels of CAM chips, many additional CAM chips can be added to the system with a sub-linear increase in the system latency.

### FIELD OF THE INVENTION

The present invention relates generally to content addressable memory and more particularly, the present invention relates to a multiple content addressable memory architecture.

### BACKGROUND OF THE INVENTION

An associative memory system called Content Addressable Memory (CAM) has been developed to permit its memory cells to be referenced by their contents. Thus CAM has found use in lookup table implementations such as cache memory subsystems and is now rapidly finding use in networking systems. CAM's most valuable feature is its ability to perform a search and compare of multiple locations as a single operation, in which search data is compared with data stored within the CAM. Typically search data is loaded onto search lines and compared with stored words in the CAM. During a search-and-compare operation, a match or mismatch signal associated with each stored word is generated on a matchline, indicating whether the search word matches a stored word or not.

A CAM stores data in a matrix of cells, which are generally either SRAM based cells or DRAM based cells. Until recently, SRAM based CAM cells have been most common because of their relatively simpler implementation than DRAM based CAM cells. However, to provide ternary state CAMs, ie. where each CAM cell can store one of three values: a logic “0”, “1” or “don't care” result, ternary SRAM based cells typically require many more transistors than ternary DRAM based cells. As a result, ternary SRAM based cells have a much lower packing density than ternary DRAM based cells.

A typical DRAM based CAM block diagram is shown in FIG. 1. The CAM 10 includes a matrix, or array 25, of DRAM based CAM cells (not shown) arranged in rows and columns. A predetermined number of CAM cells in a row store a word of data. An address decoder 17 is used to select any row within the CAM array 25 to allow data to be written into or read out of the selected row. Data access circuitry such as bitlines and column selection devices, are located within the array 25 to transfer data into and out of the array 25. Located within CAM array 25 for each row of CAM cells are matchline sense circuits, which are not shown, and are used during search-and-compare operations for outputting a result indicating a successful or unsuccessful match of a search word against the stored word in the row. The results for all rows are processed by the priority encoder 22 to output the address (Match Address) corresponding to the location of a matched word. The match address is stored in match address registers 18 before being output by the match address output block 19. Data is written into array 25 through the data I/O block 11 and the various data registers 15. Data is read out from the array 25 through the data output register 23 and the data I/O block 11. Other components of the CAM include the control circuit block 12, the flag logic block 13, the voltage supply generation block 14, various control and address registers 16, refresh counter 20 and JTAG block 21.

The match address provided by the CAM as a result of a search-and-compare operation can then be used to access data stored in conventional memories such as SRAM or DRAM for example. In the event that stored data at multiple match address locations within the CAM match the search data, also known as a “hit”, a priority scheme is used to select the match address location is to be returned. For example, one arrangement is to provide the lowest physical match address, which is closest to the null value address, from a plurality of match addresses.

Because existing semiconductor technology can only produce reliable CAM chips of limited size, where the capacity of each CAM chip is limited to a particular density. For example, current high-density CAM chips available in the market have a storage density of 18M bits. However, there are applications that require, and would benefit, from very large lookup tables that could not be provided by a single CAM chip. Thus, multiple CAM chips are used together to create a very large lookup table. For example, if each CAM has capacity m, then n chips will result in a capacity of n×m. In order to distinguish between match addresses from different CAM chips of the system, each match address provided by a CAM chip includes a base match address and a CAM chip device ID address. The base match address is generated by each CAM chip, and more than one CAM chip can generate the same base match address in a search operation. The CAM chip device ID address is distinct for each CAM chip, and represents the priority assignment of that CAM chip. Therefore, match addresses provided by a system of CAM chips will be understood as including a base match address and a CAM chip device ID address from this point forward.

The multiple CAM chips are typically mounted onto a printed circuit board (PCB), or module, and arranged in a configuration to permit the individual CAM chips to receive search instructions and collectively determine the highest priority match address to provide. Although there are many possible multiple CAM chip architectures for determining the highest priority match address among the system of multiple CAM chips, their search times, called search latency, are unacceptably high due to the number of CAM chips in the system. The search latency of the CAM system is understood as being the amount of time between receiving a search instruction and providing the highest priority match address and associated information such as multiple match flag and match flag for example, and can be expressed by the number of clock cycles. The clock cycle latency of a single CAM chip is six clock cycles, but the search latency of a cascaded CAM system becomes larger, and increases with the number of CAM chips in the system.

A linear CAM chip configuration for a CAM system is illustrated in FIG. 2. Five CAM chips, 50, 52, 54, 56 and 58, for example, are arranged in a linear or “daisy chain” configuration. Each CAM chip is coupled in parallel to a common bus labelled INSTR that carries CAM instructions, such as a search instruction, and search data from a microprocessor or ASIC chip of the external system. The daisy chain system of FIG. 2 provides the highest priority match address MA_system and associated information. Only MA_out is shown in FIG. 2 for simplicity. Each of the CAM chips are identical to each other and include an instruction input INST_in, a match address input MA_in, a match flag input MF_in, a match address output MA_out, and a match flag output MF_out. Each CAM chip is assigned a level of priority such that any match address provided from its match address output will have a higher priority than any match address provided from a CAM chip of lower priority. In FIG. 2, CAM chips 50 to 58 have a descending order of priority such that CAM chip 50 has the highest priority and CAM chip 58 has the lowest priority. With the exception of CAM chips 50 and 58, each CAM chip receives a match address and a match flag from a higher priority CAM chip, and provides a match address and a match flag to a lower priority CAM chip. The first CAM chip 50 has its match address input MA_in and match flag input MF_in grounded because it is the first CAM chip in the chain. The last CAM chip 58 provides the final match address MA_system and match flag MF to the external system since it is the last CAM chip in the system. Although many CAM chip signals, such as a clock signal, are not shown in FIG. 2, those of skill in the art will understand that they are required to enable proper CAM chip functionality. The general operation of the CAM system of FIG. 2 is now described with reference to the timing diagram of FIG. 3. FIG. 3 shows signal traces for CAM chip instruction signal line INSTR and match address output signal lines MA_{—}0, MA_{—}1, MA_{—}2, MA_{—}3 and MA_system for 11 clock cycles CLK. Generally, each CAM chip receives a search instruction with search data in parallel such that each CAM chip simultaneously generates its own local match address. Each CAM chip withholds its local match address from its MA_out output, and thus remains idle until a match address is received on its MA_in input, with the exception of CAM chip 50 which has its MA_in input grounded. The grounded input permits CAM chip 50 to provide its local match address immediately after it is generated. Each CAM chip of the system then determines and provides the higher priority match address between the one received at its MA_in input and the one it locally generated. In the event that a CAM device does not find a match, it will report a null default address of “00000” and its match flag will not be asserted. Therefore, successive CAM chips remain idle until they have been passed a match address. The method previously described for activating a CAM chip to provide its match address is one example only. There are other methods known in the art for signalling another CAM chip to provide its match address, and therefore will not be discussed.

In the following example, it is assumed that there is a match in CAM chips 52, 54 and 56. At clock cycle 0, a search instruction is received by CAM chips 50, 52, 54 and 56. Because of the six clock cycle latency per CAM chip to provide the search result, output MA_{—}0 of CAM chip 50 provides a null address at clock cycle 6. At clock cycle 7, CAM chip 52 has compared the null address from MA_{—}0 to its internally generated match address and provides match address “add_{—}1” since there was no higher priority address from CAM chip 50. Because CAM chip 52 has generated its own match address, it asserts its match flag. At clock cycle 8, CAM chip 54 has compared its match address to “add_{—}1” of MA_{—}1 and passed “add_{—}1” and asserted its match flag since the match address from CAM chip 50 is the higher priority address. Eventually, “add_{—}1” appears on MA_system at clock cycle 10 and the final match flag signal MF is asserted. Address comparisons are performed by evaluating the state of the match flag provided from the higher priority CAM chip. If the state of the match flag indicates that a matching address was found, then the subsequent lower priority CAM chip passes the higher priority match address. This passing function can be implemented through a multiplexor circuit controlled by the match flag signal, which is well known in the art.

Note that each device or chip has a 6 clock cycle latency to provide its search result. However, there is a cost resulting from cascading multiple CAM chips together in the daisy chain configuration. Specifically, with one device, the latency is 6. With two chips, the latency increases to 7: an inherent latency of 6 cycles plus one for forwarding the search result from CAM_{—}0 to CAM_{—}1. Similarly, with three chips, the latency increases to 8. It is evident in this example that the overall latency of the arrangement increases with the number of chips. If there are m chips in a daisy chain then the overall latency is 6 clock cycles +m. This linearly increasing latency for providing the system match address is undesirable because the overall latency of the CAM system will become unacceptable for large daisy chain arrangements.

An alternative multiple CAM chip arrangement referred to as “multi-drop” cascade is illustrated in FIG. 4. Four CAM chips 60, 62, 64 and 66 are arranged in parallel with each other. An instruction bus, for carrying a search instruction and search data for example, is connected to each CAM chip, and a match address bus is connected to each CAM chip match address output MA_out for carrying match address data to the external system. Although not shown, each CAM chip also receives a clock signal in parallel. In FIG. 4, CAM chips 60 to 66 have a descending order of priority such that CAM chip 60 has the highest priority and CAM chip 66 has the lowest priority.

In general operation, a search instruction is sent along the instruction bus to each CAM device. All four CAM chips execute the search operation in parallel and may each have at least one matching address. Since more than one CAM chip can have a matching address, minimal additional logic and links to connect each other are added to each CAM chip such that the CAM chips can exchange single bit information with each other in order to determine which CAM chip has the right to reserve the common address bus to send the highest priority matching address. Thus the lower priority CAM chips among CAM chips having a match are inhibited from driving the match address bus with their match address. However, the amount of time needed to search all chips increases with the number of chips.

The configuration of the “multi-drop” architecture requires the implementation of long metal conductor lines on the PCB for the instruction bus and the address bus. These long metal lines have inherent parasitic capacitance and resistance that increasingly delays the propagation of high speed digital signals as the number of CAMs increases. Using the configuration of FIG. 4 by example, it is assumed that the search instruction takes 1 ns to reach CAM chip 60, 2 ns to reach CAM chip 62, 3 ns to reach CAM chip 64 and 4 ns to reach CAM chip 66. If 1 ns is required to latch the instruction and another 1 ns is required to execute the search in each CAM chip, then the search operation at the last CAM chip 66 in the multi-drop configuration starts 6 ns after the search instruction is provided by the external system. However, another 4 ns is required to send the match address result from CAM chip 66 to the external system, resulting in a worst case extra 10 ns response time in addition to the 6 clock cycle latency required for each CAM chip to provide its search results. If a 9 ns clock is used, then the entire CAM chip system will not meet operating specifications, because receipt of the CAM system search results are expected within 1 clock cycle. Thus a slower clock would have to be used, effectively increasing the clock cycle period. Unfortunately, using a slower clock is not a desirable solution since the response time increases with the number of chips in the multi-drop configuration. Furthermore, the response time will increase as more CAM chips are added to the system of FIG. 4 because longer metal conductor lines would be required to them to the instruction bus and the address bus. Therefore a number of CAM chips arranged within the system is limited. Hence the speed limitation of the long conductor lines limits the speed performance of the system. Additionally, consumer demands push technology to increase clock speeds, further limiting the practicality of the multi-drop architecture.

It is, therefore, desirable to provide an arrangement for a large number of CAM chips which provides CAM search results at high speed. Specifically, it is desirable to provide an arrangement of CAM chips in which the response time of the CAM chip system is less dependent upon the number of CAM chips within the system.

### SUMMARY OF THE INVENTION

It is an object of the present invention to obviate or mitigate at least one of the disadvantages described above. More specifically, it is an object of the present invention to provide a content addressable memory system architecture that minimizes search latency for a given number of content addressable memories.

In a first aspect, the present invention provides a system of content addressable memories for receiving a clock signal, and for providing a system match address in response to a received search instruction. The system includes an input content addressable memory for generating input match data in response to the search instruction, a first content addressable memory network for receiving the input match data, and for generating first local match data in response to the search instruction, a second content addressable memory network for receiving the input match data, and for generating second local match data in response to the search instruction, and an output content addressable memory for receiving the first match data and the second match data, and for generating output match data in response to the search instruction. The first content addressable memory network provides first match data corresponding to the highest priority match data between the first local match data and the input match data at least one clock cycle after the input match data is generated. The second content addressable memory network provides second match data corresponding to the highest priority match data between the second local match data and the input match data at least one clock cycle after the input match data is generated. The output content addressable memory providing the system match address corresponding to the highest priority match data between the first match data, the second match data and the output match data at least one clock cycle after receiving the first match data and the second match data.

In an embodiment of the present aspect, the first content addressable memory network and the second content addressable memory network can each include a single content addressable memory, and the input content addressable memory, the first content addressable memory network, the second content addressable memory network and the output content addressable memory are assigned different levels of priority.

In a further embodiment of the present aspect, the input match data, the first match data, the second match data and the output match data include respective match address data and match flag data, and the input match address data, the first match address data, the second match address data and the output match address data includes respective base match address data and device ID address data.

In yet another embodiment of the present aspect, the first and the second content addressable memory networks each include a plurality of content addressable memories arranged in a diamond cascade configuration, and the content addressable memories are arranged in logical levels such that the system search latency is a sum of the number of clock cycles equal to the number of logical levels of content addressable memories and the search latency per content addressable memory.

In a second aspect, the present invention provides a system of content addressable memories arranged in logical levels for receiving a clock signal, each logical level of content addressable memories receiving a search instruction in successive clock cycles and each content addressable memory generating local match data in response to the search instruction. The system includes a first content addressable memory in a first logical level, a second content addressable memory in a second logical level, a third content addressable memory in the second logical level, a fourth content addressable memory in a third logical level, a fifth content addressable memory in the third logical level, a sixth content addressable memory in the third logical level, a seventh content addressable memory in the third logical level, an eighth content addressable memory in a fourth logical level, a ninth content addressable memory in the fourth logical level, and a tenth content addressable memory in a fifth logical level. The first content addressable memory provides first match data corresponding to its local match data in a first clock cycle. The second content addressable memory receives the first match data, provides second match data corresponding to the highest priority match data between its local match data and the first match data in a second clock cycle. The third content addressable memory receives the first match data, and provides third match data corresponding to the highest priority match data between its local match data and the first match data in the second clock cycle. The fourth content addressable memory receives the second match data, and provides fourth match data corresponding to the highest priority match data between its local match data and the second match data in a third clock cycle. The fifth content addressable memory receives the second match data, and provides fifth match data corresponding to the highest priority match data between its local match data and the second match data in the third clock cycle. The sixth content addressable memory receives the third match data, and provides sixth match data corresponding to the highest priority match data between its local match data and the third match data in the third clock cycle. The seventh content addressable memory receives the third match data, and provides seventh match data corresponding to the highest priority match data between its local match data and the third match data in the third clock cycle. The eighth content addressable memory receives the fourth and fifth match data, and provides eighth match data corresponding to the highest priority match data between its local match data, the fourth match data and the fifth match data in a fourth clock cycle. The ninth content addressable memory receives the sixth and seventh match data, and provides ninth match data corresponding to the highest priority match data between its local match data, the sixth match data and the seventh match data in the fourth clock cycle. The tenth content addressable memory receives the eighth and ninth match data, and provides final match data corresponding to the highest priority match data between its local match data, the eighth match data and the ninth match data in a fifth clock cycle.

In an embodiment of the present aspect, the first through tenth content addressable memories have a decreasing order of priority.

In a third aspect, the present invention provides a method of searching a system of content addressable memories for a match address after passing a search instruction to each content addressable memory. The method includes the steps of generating input match address data in an input content addressable memory in response to the search instruction, comparing in parallel the input match address data and respective local match address data generated from parallel content addressable memory networks to determine intermediate match address data corresponding to each parallel content addressable memory network, and comparing the intermediate match address data and output match address data generated in an output content addressable memory to determine a system match address.

In an embodiment of the present aspect, the system of content addressable memories are arranged in logical levels, and the search instruction is passed to each logical level of content addressable memories at each successive clock cycle.

In another embodiment of the present aspect, the input match address data, local match address data, intermediate match address data and output match address data include respective match address data and match flag data.

In an alternate embodiment of the present aspect, the step of comparing in parallel further includes comparing the match flag data of the input match address data and respective local match address data generated from the content addressable memory networks.

In a further alternate embodiment of the present aspect, the step of comparing the intermediate match address data further includes comparing the match flag data of the input match address data and respective local match address data generated from the content addressable memory networks.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a block diagram of a typical DRAM based CAM chip;

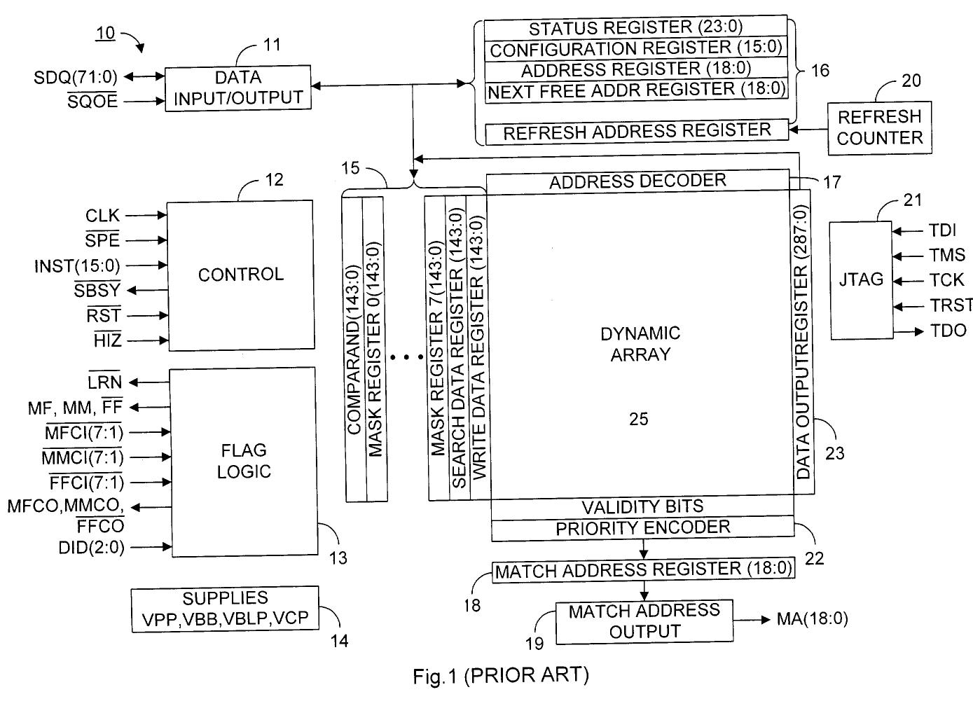

FIG. 2 is a schematic of a daisy chain configured CAM chip system;

FIG. 3 is a timing diagram illustrating the operation of the CAM chip system of FIG. 2;

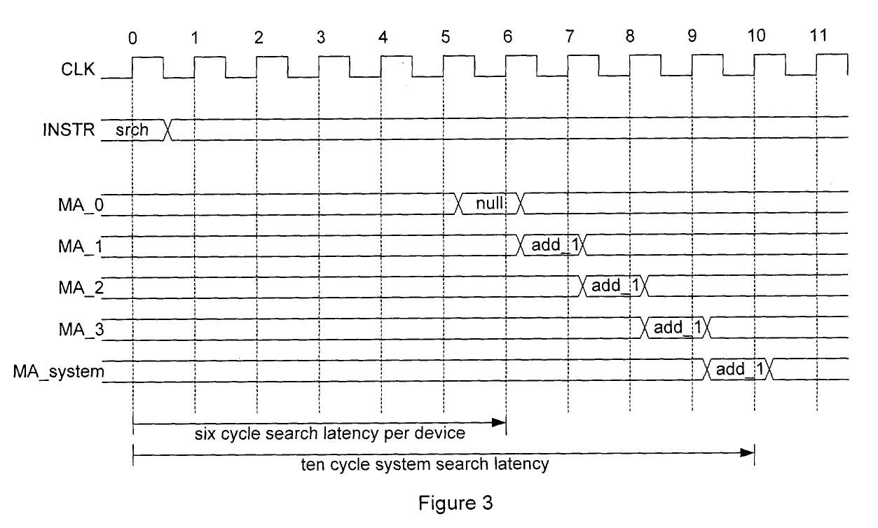

FIG. 4 is a schematic of a multi-drop configured CAM chip system;

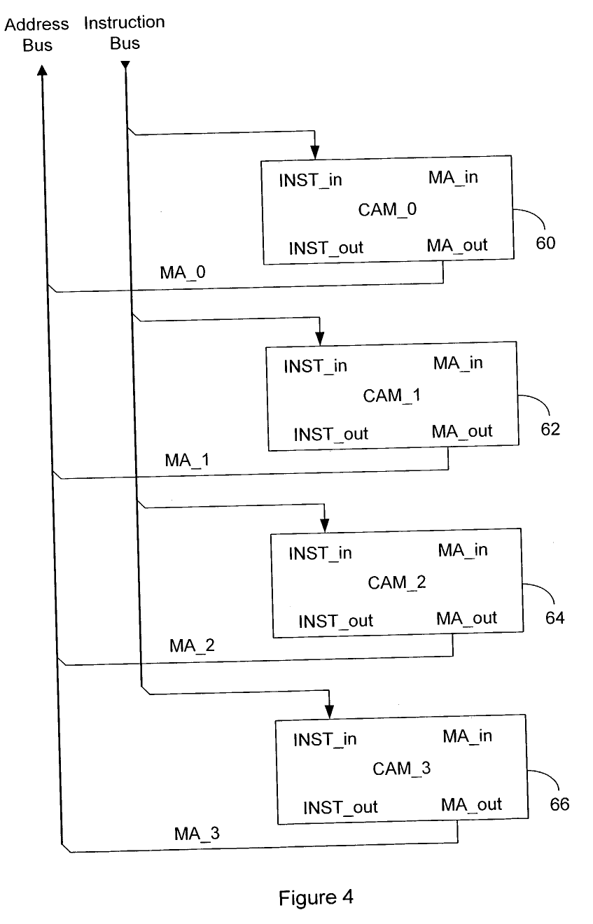

FIG. 5 is a general block diagram of a diamond cascade configured CAM chip system according to an embodiment of the present invention;

FIG. 6 is a schematic of a ten CAM chip diamond cascade configured CAM chip system according to an embodiment of the present invention;

FIG. 7 is a timing diagram illustrating the search instruction operation of the CAM chip system of FIG. 6; and,

FIG. 8 is a timing diagram illustrating the match result output operation of the CAM chip system of FIG. 6.

### DETAILED DESCRIPTION

Generally, the present invention provides a multiple CAM chip architecture for a CAM memory system. The CAM chips are arranged in a diamond cascade configuration such that the base unit includes an input CAM chip, two parallel CAM chip networks, and an output CAM chip. The input CAM chip receives a CAM search instruction and provides the search instruction and any match address simultaneously to both CAM chip networks for parallel processing of the search instruction. Each CAM chip network provides the highest priority match address between the match address of the input CAM chip and its own match address. The output CAM chip then determines and provides the highest priority match address between the match addresses of both CAM chip networks and its own match address. Each CAM chip network can include one CAM chip, or a plurality of CAM chips arranged in the base unit diamond cascade configuration. Because the clock cycle latency of the diamond cascade configured CAM memory system is determined by sum of the inherent CAM chip search latency and the number of parallel levels of CAM chips, many additional CAM chips can be added to the system with a sub-linear increase in the system latency.

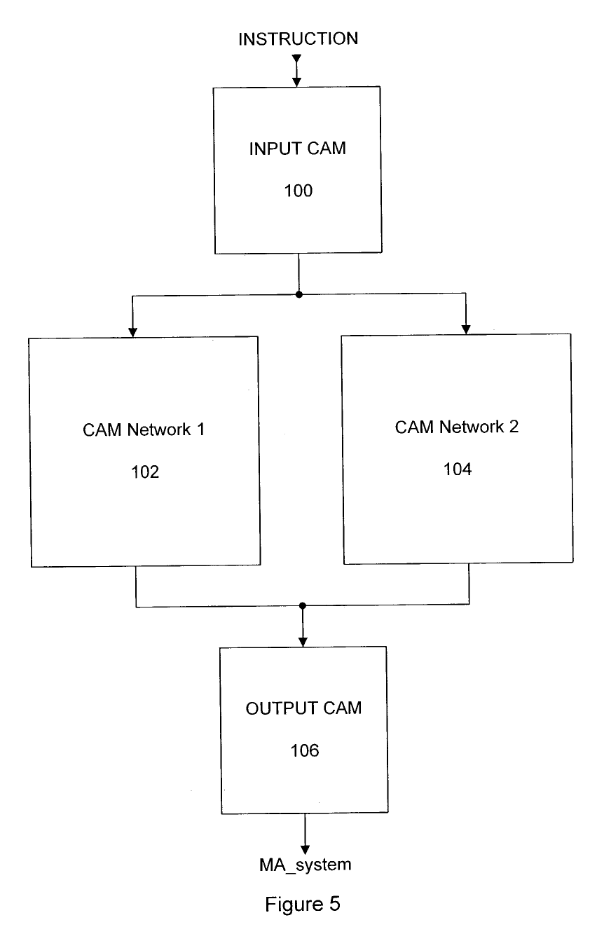

A block diagram of the diamond cascade CAM chip system according to an embodiment of the present invention is shown in FIG. 5. It is assumed from this point forward that each CAM chip is connected to the external system via pins to permit execution of standard CAM chip data read and write operations for example, and that the CAM chips have already been written with data to be searched. Therefore those connections to the external system are not shown to simplify the figures. The base unit diamond cascade CAM chip system includes an input CAM chip 100 of a first level, two CAM chip networks 102 and 104 of a second level, and an output CAM chip 106 of a third level arranged in the shape of a diamond. More significant however is the interconnection between the CAM chips and the CAM chip networks. Only input CAM chip 100 receives a CAM search instruction from the external system. As shown in FIG. 5, CAM chip 100 is connected in parallel to CAM chip networks 102 and 104 for passing its received instruction and its match address, if any. Output CAM chip 106 receives the instruction INSTRUCTION passed from either of CAM chip networks 102 and 104, and a match address from both CAM chip networks 102 and 104 for providing a match address for the CAM system MA_system. Although simple lines illustrate the interconnection between the CAM chips and the CAM networks, they generally represent the flow of match data, where the match data can include the match address, match flag and other signals related to the CAM chip or network from where it originated. Each CAM chip network 102 and 104 can include a single CAM chip, or another base unit diamond cascade CAM chip system, which itself can include additional base units within their respective CAM chip networks. Although not shown, each CAM chip of the system receives the same system clock.

With respect to the priority mapping of the diamond cascade system, input CAM chip 100 is assigned the highest priority and output CAM chip 106 is assigned the lowest priority. Both CAM chip networks 102 and 104 have lower priorities than input CAM 100, but higher priorities than output CAM 106. In this particular example, CAM chip network 102 has a higher priority than CAM chip network 104, but this mapping can be swapped in alternate embodiments of the present invention. As previously mentioned, CAM chip priority assignments can be made through the use of device-ID pins, such that input CAM chip 100 is assigned binary value 0000, CAM chip network 102 is assigned binary value 0001 and so forth, for example.

In operation, input CAM chip 100 receives a search instruction INSTRUCTION, which includes search data, in a first clock cycle and proceeds to execute the search. In a second clock cycle, the search instruction is passed by CAM chip 100 to CAM chip networks 102 and 104, where they begin their respective search for the search data. The present example assumes that CAM chip networks 102 and 104 each include a single CAM chip. In a third clock cycle, the search instruction is passed by one of CAM chip networks 102 and 104 to output CAM chip 106, which then begins its search for the search data. Hence the externally supplied search instruction INSTRUCTION cascades through the CAM chip system to initiate the search operation in each CAM chip. Eventually at six clock cycles after receiving the search instruction, input CAM 100 provides its match address, if any, to both CAM chip networks 102 and 104. If CAM chip networks 102 and 104 have received a match address from CAM chip 100, then they immediately pass that match address one clock cycle after they received it as it has a higher priority than any match address generated locally within their respective CAM chip networks. Otherwise, if no match address was received from input CAM 100, then CAM chip networks 102 and 104 determine and provide their own respective local match addresses if any are found. Thus the match addresses provided by CAM chip networks 102 and 104 are considered intermediate match addresses that represent the result of comparisons in each CAM chip network between locally generated match addresses and the match address from CAM 100. If output CAM chip 106 receives match addresses (for example) from CAM chip networks 102 and 104, then output CAM chip 106 immediately passes the match address from CAM chip network 102 because it has the higher priority, at one clock cycle after the match addresses are received. Otherwise, if no match address is received by output CAM chip 106, then it provides its own match address as the match address of the CAM chip system MA_system, if any.

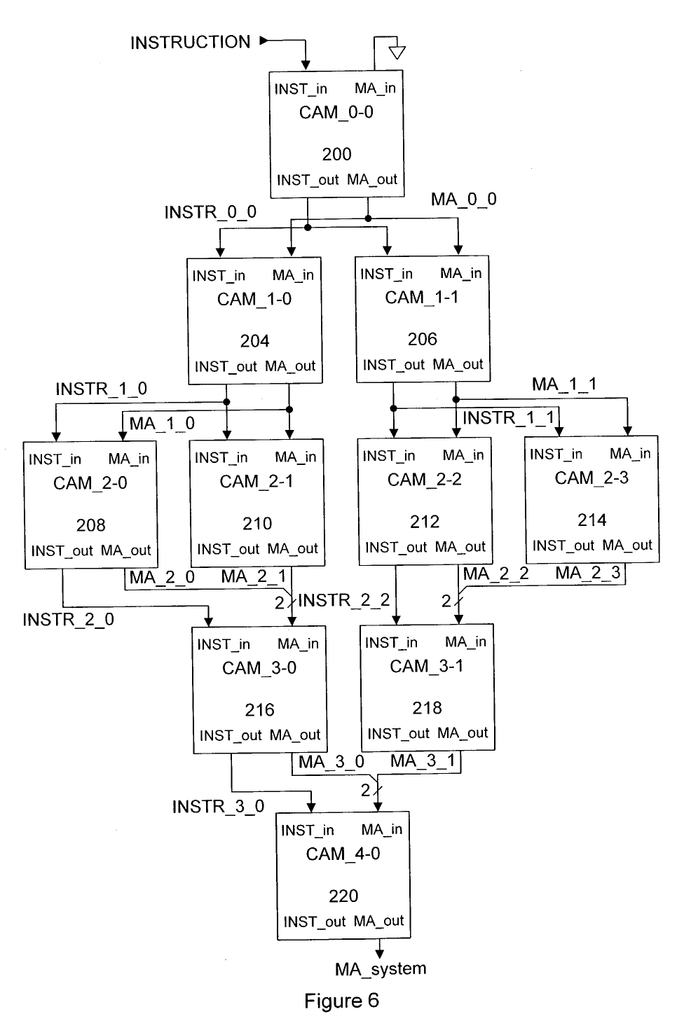

In summary, any CAM chip that receives a match address from a higher priority CAM chip passes the higher priority match address instead of its locally generated match address. Furthermore, because the two CAM chip networks 102 and 104 execute their search in parallel, the total CAM chip system search latency is now determined by the number of sequential CAM chip levels, i.e three in FIG. 5, and not by the number of CAM chips in the system. Therefore the overall system search latency grows sublinearly with the number of chips added to the diamond cascade configured CAM chip system. The sublinear search latency growth with CAM chip number is better illustrated with the ten CAM chip diamond cascade CAM chip system shown in FIG. 6.

The diamond cascade CAM chip system of FIG. 6 includes an input CAM chip 200, a first CAM chip network consisting of CAM chips 204, 208, 210 and 216, a second CAM chip network consisting of CAM chips 206, 212, 214 and 218, and an output CAM chip 220. It is noted that the first and second CAM chip networks are each essentially similar to the base unit diamond cascade CAM chip system previously discussed with respect to FIG. 5. All the CAM chips are identical to each other, and have an instruction input INST_in, a match address input MA_in, an instruction output INST_out, and a match address output MA_out. All the CAM chips also include match and multiple match flag inputs and outputs that are not shown in order to simplify the schematic. In this particular embodiment, each match flag input is configured to receive two separate match flag signals from respective higher priority CAM chips. Although MA_in appears as a single input terminal, each MA_in is configured to receive two separate match addresses. Input CAM chip 200 receives external system instruction INSTRUCTION, has both its MA_in inputs and match flag inputs grounded, and provides a match address, a match flag and the external system instruction to CAM chips 204 and 206. CAM chips 204 and 206 are fan-out CAM chips that provide the external system instruction and their respective match address and match flags to two other CAM chips in parallel, such as CAM chips 208 and 210 for fan-out CAM chip 204, and CAM chips 212 and 214 for fan-out CAM chip 206. For practical purposes, input CAM chip 200 can also be considered a fan-out CAM chip. CAM chips 208, 210, 212 and 214 are transitional CAM chips that each receives a single match address through its MA_in input and provides a respective match address to a single CAM chip, such as CAM chips 216 and 218. The fan-out CAM chips 204, 206 and transitional CAM chips 208, 210, 212, 214 have one of their MA_in inputs and one of their match flag inputs remain grounded because they are not used. CAM chips 216 and 218 are fan-in CAM chips that each receives two match addresses address through its MA_in input, two match flags, and provides a respective match address and match flag to a single CAM chip, such as output CAM chip 220. In this particular embodiment, fan-in CAM chip 216 passes the external system instruction to output CAM chip 220, although fan-in CAM chip 218 can equivalently pass the external system instruction instead. Output CAM chip 220, also considered a fan-in CAM chip, provides the highest priority match address of the diamond cascade CAM chip system of FIG. 6 via signal line MA_system. Although not shown, CAM chip 220 also provides a match flag to the external system for indicating that a matching address has been found.

In the present system of FIG. 6, there are five sequential CAM chip levels. The first level includes input CAM chip 200, the second level includes CAM chips 204 and 206, the third level includes CAM chips 208, 210, 212 and 214, the fourth level includes CAM chips 216 and 218, and the fifth level includes output CAM chip 220. The priority mapping of the diamond cascade CAM chip system of FIG. 6 is as follows. The priority level decreases with each sequential level of CAM chips such that CAM chip 200 has the highest priority while CAM chip 220 has the lowest priority. Furthermore, the priority of the CAM chips decreases from the left to the right side of the schematic. For example, CAM chip 204 has a higher priority than CAM chip 206, and CAM chip 210 has a higher priority than CAM chip 212. As previously explained, device-ID pins can be used to assign priorities to each CAM chip.

Prior to a discussion of the operation of the embodiment of the invention shown in FIG. 6, the general function of each CAM chip within the system is now described. Each CAM chip can receive two external match addresses through its MA_in input, two match flags,and can generate its own local match address and match flag, but will only provide the highest priority match address on its MA_out output. The MA_in input includes left and right MA_in inputs, where either the left or right MA_in input is set within the CAM chip to be a higher priority than the other. In the system of FIG. 6, the left MA_in input has a higher priority than the right MA_in input in each CAM chip. As previously mentioned, each CAM chip can include a multiplexor for passing one of three possible match addresses, and the multiplexor can be controlled by decoding logic that is configured to understand the priority order of the match flags. Those of skill in the art will understand that there are different possible logic configurations for determining signal priority, and therefore does not require further description. Hence, the CAM chip passes the match address corresponding to the highest priority match flag received. If there are no match addresses to pass, the CAM chip preferably provides a null “don't care” match address of “00000”.

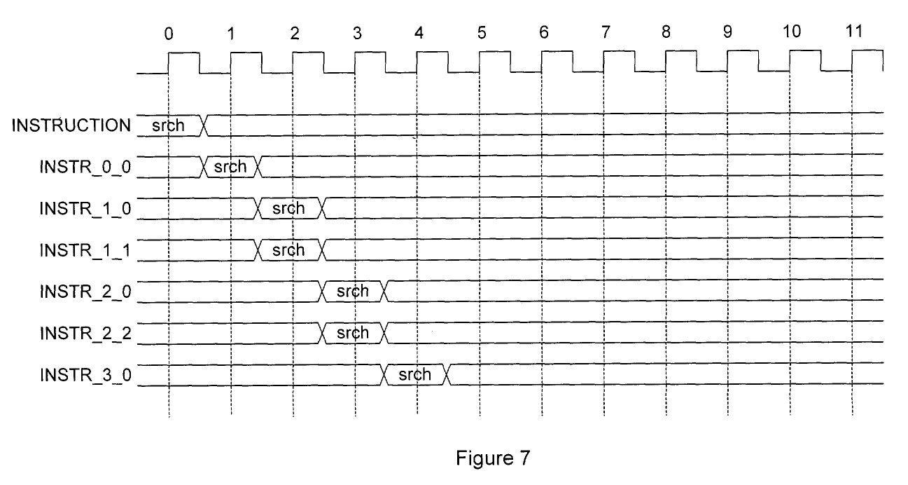

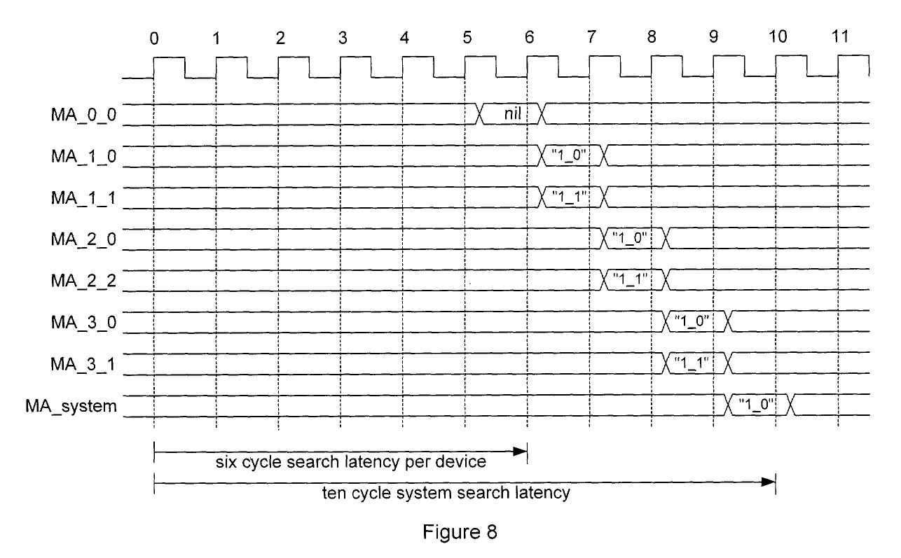

A search operation of the diamond cascade CAM chip system of FIG. 6 is now described with reference to FIG. 6 and the timing diagrams of FIGS. 7 and 8. It is assumed in the following example that there is one match in all the CAM chips except CAM chip 200. A search instruction labelled “srch” including the search data is received by CAM chip 200 at clock cycle 0 to initiate its search operation. At clock cycle 1, the search instruction is simultaneously passed to CAM chips 204 and 206 via signal line INSTR_{—}0_{—}0. At clock cycle 2, the search instruction is simultaneously passed to CAM chips 208 and 210 via signal line INSTR_{—}1_{—}0, and CAM chips 212 and 214 via signal line INSTR_{—}1_{—}1. At clock cycle 3, the search instruction is simultaneously passed to CAM chip 216 via signal line INSTR_{—}2_{—}0, and CAM chip 218 via signal line INSTR_{—}2_{—}2. At clock cycle 4, the search instruction is passed to CAM chip 220 via signal line INSTR_{—}3_{—}0. Due to the inherent six clock cycle search latency per CAM chip, CAM chip 200 does not provide its null address on signal line MA_{—}0_{—}0 until clock cycle 6, as shown in FIG. 8. Because a null address is received from CAM chip 200, CAM chip 204 drives signal line MA_{—}1_{—}0 with its locally generated match address, labelled “1_{—}0” and CAM chip 206 drives signal line MA_{—}1_{—}1 with its locally generated match address, labelled “1_{—}1” at clock cycle 7. At clock cycle 8, CAM chips 208 and 210 generate their own local match addresses, but both pass match address “1_{—}0” because it has a higher priority match address than their respective local match addresses. Similarly during clock cycle 8, CAM chips 212 and 214 generate their own local match addresses, but both pass match address “1_{—}1” because it has a higher priority match address than their respective local match addresses. Therefore signal lines MA_{—}2_{—}0 and MA_{—}2_{—}1 are driven with match address “1_{—}0” while signal line MA_{—}2_{—}2 and MA_{—}2_{—}3 are driven with match address “1_{—}1”. At clock cycle 9, CAM chip 216 generates a local match address, but drives signal line MA_{—}3_{—}0 with match address “1_{—}0” because it has a higher priority than the local match address. Similarly, CAM chip 218 generates a local match address, but drives signal line MA_{—}3_{—}1 with match address “1_{—}1” because it has a higher priority than the local match address. At clock cycle 10, CAM chip 220 generates a local match address, but drives signal line MA_system with match address “1_{—}0” because it has a higher priority than both the match address “1_{—}1” and the local match address. Therefore the highest priority match address, “1_{—}0” from CAM chip 204, is provided to the external system at ten clock cycles after the initial instruction is provided to the system at clock cycle 0.

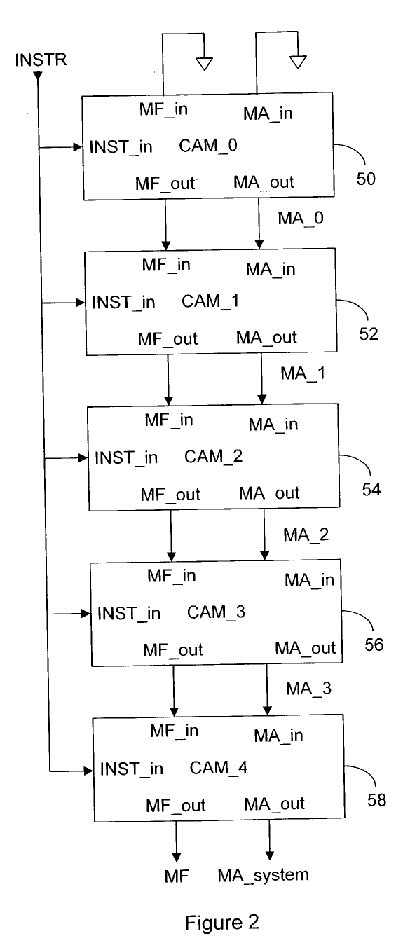

Although there are ten CAM chips in the diamond cascade CAM chip system of FIG. 6, the overall system search latency of ten clock cycles is equivalent to the five CAM chip daisy chain configured system shown in FIG. 2. This is because the system is limited to five sequential CAM chip levels, where up to four CAM chips perform their search operations simultaneously in the same clock cycle. Furthermore, the interconnections between CAM chips can be maintained at a relatively short length because each CAM chip only needs to be connected with CAM chips having a priority immediately higher or lower than itself. Although the system of FIG. 6 takes on the general shape of a diamond, a person of skill in the art will understand that this is a conceptual layout that does not reflect the practical board-level layout of the system. While the practical board-level layout of the system may not reflect the shape of a diamond, the interconnections between CAM chips would be maintained and the clock signal connection to all the CAM chips would be better facilitated. In particular, techniques such as line “tromboning” are well known in the industry for ensuring that each CAM chip receives the clock signal within acceptable tolerances, such as within 300 picoseconds of each other. Alternatively, clock drivers can be used to achieve this result.

As previously mentioned, numerous CAM chips can be arranged in the diamond cascade CAM chip configuration according to the embodiments of the present invention with a sublinear increase in the overall system search latency. For example, a 22 CAM chip system arranged in the diamond cascade configuration according to an alternate embodiment of the present invention would require seven sequential CAM chip levels, and have a corresponding overall system search latency of 13 clock cycles. When compared to the ten CAM chip embodiment of FIG. 6, the 22 CAM chip embodiment has more than double the number of chips, but only at the cost of three additional clock cycles. In another alternate embodiment of the present invention, each CAM chip can compare CAM device ID addresses of the match addresses to determine the highest priority match address between a locally generated match address and externally received match addresses instead of comparing match flag signals.

In an alternate embodiment of the present invention, each fan-out CAM chip can feed its match data to three or four other CAM chips in parallel, instead of two as illustrated in FIGS. 5 and 6. Accordingly, each fan-in CAM chip would receive three or four match data outputs. The selection of the system architecture depends on the performance criteria to be satisfied. Given a fixed number of CAM chips, latency can be minimized by minimizing the number of logical levels, or rows of CAM chips. However, to maximize the search rate, the fan-out and fan-in values should be minimized, ie. with a fan-out/fan-in value of two as shown in the presently illustrated embodiments. Although latency can be minimized, in this method, increased capacitive loading of the shared lines would reduce the overall system speed of operation.

Although a search operation is described for the above described embodiment of the diamond cascade multiple CAM system, those of skill in the art will understand that other standard CAM operations can be executed, such as read and write operations for example, and that CAM status signals such as the match and the multiple match flags are supported in the diamond cascade systems according to the embodiments of the present invention.

The diamond cascade CAM chip system according to the embodiments of the present invention can include a large number of CAM chips without a corresponding increase in overall system search latency. The arrangement of CAM chips in the diamond cascade configuration avoids the use of long wiring lines because each CAM chip only needs to communicate information to CAM chips one level of priority higher and lower than itself. Therefore significant RC wiring delays are avoided and system performance is not hampered. The diamond cascade CAM chip system is glueless, in that no additional devices are required to provide system functionality, ensuring transparent operation to the user. For example, the user only needs to provide a standard CAM search instruction without additional control signals in order to receive a match address, if any.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A system of content addressable memories for receiving a clock signal, and for providing a system match address in response to a received search instruction, the system comprising:
an input content addressable memory for generating input match data in response to the search instruction;
a first content addressable memory network for receiving the input match data, and for generating first local match data in response to the search instruction, the first content addressable memory network providing first match data corresponding to the highest priority match data between the first local match data and the input match data at least one clock cycle after the input match data is generated;
a second content addressable memory network for receiving the input match data, and for generating second local match data in response to the search instruction, the second content addressable memory network providing second match data corresponding to the highest priority match data between the second local match data and the input match data at least one clock cycle after the input match data is generated; and,
an output content addressable memory for receiving the first match data and the second match data, and for generating output match data in response to the search instruction, the output content addressable memory providing the system match address corresponding to the highest priority match data between the first match data, the second match data and the output match data at least one clock cycle after receiving the first match data and the second match data.

2. The system of claim 1, wherein the first content addressable memory network and the second content addressable memory network each include a single content addressable memory.

3. The system of claim 1, wherein the input content addressable memory, the first content addressable memory network, the second content addressable memory network and the output content addressable memory are assigned different levels of priority.

4. The system of claim 1, wherein the input match data, the first match data, the second match data and the output match data include respective match address data and match flag data.

5. The system of claim 4, wherein the input match address data, the first match address data, the second match address data and the output match address data includes respective base match address data and device ID address data.

6. The system of claim 1, wherein the first and the second content addressable memory networks each include a plurality of content addressable memories arranged in a diamond cascade configuration.

7. The system of claim 6, wherein the content addressable memories are arranged in logical levels and the system search latency is a sum of the number of clock cycles equal to the number of logical levels of content addressable memories and the search latency per content addressable memory.

8. A system of content addressable memories arranged in logical levels for receiving a clock signal, each logical level of content addressable memories receiving a search instruction in successive clock cycles and each content addressable memory generating local match data in response to the search instruction, the system comprising:
a first content addressable memory in a first logical level for providing first match data corresponding to its local match data in a first clock cycle;
a second content addressable memory in a second logical level for receiving the first match data, and for providing second match data corresponding to the highest priority match data between its local match data and the first match data in a second clock cycle;
a third content addressable memory in the second logical level for receiving the first match data, and for providing third match data corresponding to the highest priority match data between its local match data and the first match data in the second clock cycle;
a fourth content addressable memory in a third logical level for receiving the second match data, and for providing fourth match data corresponding to the highest priority match data between its local match data and the second match data in a third clock cycle;
a fifth content addressable memory in the third logical level for receiving the second match data, and for providing fifth match data corresponding to the highest priority match data between its local match data and the second match data in the third clock cycle;
a sixth content addressable memory in the third logical level for receiving the third match data, and for providing sixth match data corresponding to the highest priority match data between its local match data and the third match data in the third clock cycle;
a seventh content addressable memory in the third logical level for receiving the third match data, and for providing seventh match data corresponding to the highest priority match data between its local match data and the third match data in the third clock cycle;
an eighth content addressable memory in a fourth logical level for receiving the fourth and fifth match data, and for providing eighth match data corresponding to the highest priority match data between its local match data, the fourth match data and the fifth match data in a fourth clock cycle;
a ninth content addressable memory in the fourth logical level for receiving the sixth and seventh match data, and for providing ninth match data corresponding to the highest priority match data between its local match data, the sixth match data and the seventh match data in the fourth clock cycle; and, a tenth content addressable memory in a fifth logical level for receiving the eighth and ninth match data, and for providing final match data corresponding to the highest priority match data between its local match data, the eighth match data and the ninth match data in a fifth clock cycle.

9. The system of claim 1, wherein the first through tenth content addressable memories have a decreasing order of priority.

10. A method of searching a system of content addressable memories for a match address after passing a search instruction to each content addressable memory, comprising:
a) generating input match address data in an input content addressable memory in response to the search instruction;
b) comparing in parallel the input match address data and respective local match address data generated from parallel content addressable memory networks to determine intermediate match address data corresponding to each parallel content addressable memory network; and,
c) comparing the intermediate match address data and output match address data generated in an output content addressable memory to determine a system match address.

11. The method of claim 10, wherein the system of content addressable memories are arranged in logical levels, and the search instruction is passed to each logical level of content addressable memories at each successive clock cycle.

12. The method of claim 10, wherein the input match address data, local match address data, intermediate match address data and output match address data include respective match address data and match flag data.

13. The method of claim 12, wherein step b) further includes comparing the match flag data of the input match address data and respective local match address data generated from the content addressable memory networks.

14. The method of claim 12, wherein step c) further includes comparing the match flag data of the intermediate match address data and output match address data.
